(19) United States
(12) Patent Application Publication
(10) Pub. No.: US 2009/0102404 A1
(43) Pub. Date: Apr. 23, 2009

(54) Control Circuit For An Electromotor With Electronic Brake Switch

(75) Inventors: Heino Marten Burema, Mierlo (NL); Gerardus Elizabeth Joseph Maria Pas, Valkenswaard (NL)

Correspondence Address: BANNER & WITCOFF, LTD., 1100 13th STREET, N.W., SUITE 1200, WASHINGTON, DC, 20005-4051, US

(73) Assignee: Electrische Apparatenfabriek Capax B.V., BA Eindhoven (NL)

(21) Appl. No.: 11/793,042

(22) PCT Filed: Dec. 16, 2005
(86) PCT No.: PCT/NL05/50084

§ 371 Date: Mar. 31, 2008

(30) Foreign Application Priority Data
Dec. 21, 2004 (NL) 1027838

(51) Int. Cl. H02P 3/12

(52) U.S. Cl. 318/380

(57) ABSTRACT

The invention relates to a control circuit for controlling a DC voltage power supply, whereby the control circuit comprises a switching element connected in series to the motor and a bypass switch connected in parallel to the electromotor for braking the electromotor by means of bypassing, with the bypass switch being formed by a semiconductor and the control circuit comprising a control circuit for controlling the bypass switch and a detector connected to the control circuit for detecting the status of the switching element. Semiconductors are less sensitive to vibrations and dirt. They are furthermore so small that they can easily be mounted on the same carrier as the other components of the control circuit. The control circuit is preferably arranged for gradually increasing the conductivity of the bypass switch once the switching element is open. Mechanical shocks when the tool is switched off are prevented by means of the partial conductivity of the semiconductor switch.

The present invention relates to a control circuit for controlling the power supplied from a DC power supply to an electromotor.

Such a control circuit is generally known with electrical devices such as electric hand tools.

When the driving motor of such a device is switched off, it is important for the device to stop as quickly as possible. This has to do with safety, in particular with respect to standing hand tools known to be dangerous, such as circular saws and right-angle grinders, but also with the desire to quickly stop the work being carried out by the tool, such as sawing or drilling, when the tool is switched off.

The stopping of the motor can be achieved by bypassing the electromotor once the electromotor has been switched off. The electromotor then works as a generator and converts the kinetic energy of the rotor of the electromotor and rotating parts of the tool connected thereto into electrical energy. This electrical energy is then dissipated in the ohmic resistance of the windings of the electromotor or in an external resistance.

To this end, such a control circuit is known from the prior art for an electric hand tool fed by a DC voltage source, whereby the control circuit is arranged for controlling the power supplied from the DC voltage source to an electromotor and whereby the control circuit incorporates a switching element connected in series to the motor and a bypass switch connected in parallel to the electromotor for braking the electromotor by means of bypassing.

Such a circuit performs its function effectively. If a mechanical switch is used as a switching element, it can be produced at a low cost price, because the bypass switch can be implemented as an additional contact of this switching element. The requirement is thus automatically met for it only to be possible to switch on the bypass switch when the switching element is switched off. A mechanical switch however forms a vulnerable component; the appliance in which the switch is mounted is frequently subjected to vibrations and dust, which reduces the life of the bypass switch, or, for an acceptable life, calls for an expensive switch.

To avoid these disadvantages, US-A-2002/0158593 describes a control circuit for an electric hand tool fed by a DC voltage source, whereby the control circuit is arranged for controlling the power supplied from the DC voltage source to an electromotor and whereby the control circuit incorporates a switching element connected in series to the motor and a bypass switch connected in parallel to the electromotor for braking the electromotor by means of bypassing, with the bypass switch being formed by a semiconductor. The circuit described in this document is only rudimentary in design. There is therefore the risk of the control circuit as well as the bypass switch being open at the same time. This would lead to a bypass.

The invention avoids this problem in that the control circuit comprises a control circuit for controlling the bypass switch and a detector connected to the control circuit for detecting the status of the switching element. By applying a detector, the control circuit knows' when the control circuit is conductive, and the bypass switch is thus prevented from closing.

According to a first preferred embodiment, the control circuit is arranged for gradually increasing the conduction of the bypass switch once the switching element is open, the bypass switch is of the switching type, and the variation in conduction of the bypass switch is achieved by varying the duty cycle of the bypass switch. During the braking process, the kinetic energy of the rotating part of the motor and the tool is converted into heat. The braking process is for a short duration, whereas the kinetic energy is substantial. The power to be converted during the braking process is therefore considerable. By using a switching converter, it is possible to avoid converting a large part of this kinetic energy in the semiconductor, as would be the case if a semiconductor with controllable conduction were applied.

According to another preferred embodiment, the switching element comprises an electronic switching element of the switching type and the control circuit comprises a control circuit that is arranged for controlling the electronic switching element. This creates a dual use for the control circuit.

Yet another preferred embodiment provides for the feature that the control circuit comprises a microprocessor. The combination of controllable brake and controllable drive makes great demands on the functionality of the control circuit for the switching element and bypass switch. The decreasing price of microprocessors makes it possible to apply such a microprocessor as a control circuit. It is surprising that such a sensitive element can also be applied in an electric tool environment with a high level of electrical interference.

The switching element connected in series to the semiconductor usually comprises a mechanical switch to meet safety requirements. It is therefore advantageous if a detector is provided for detecting the position of the mechanical switch.

This detector function is preferably implemented in that the mechanical switch is operator-controllable by means of a manually operated control element connected to a slider of a potentiometer mounted on a carrier in the switch and in that the detector comprises an auxiliary contact mounted on the carrier. This barely requires any additional measures to be taken.

When the control circuit is used during the braking process for controlling the bypass switch, the mechanical switch is open, which means that the control circuit cannot be fed by the battery. According to a preferred embodiment, the control circuit is connected to a storage reservoir for electrical energy. In this way, it is possible to feed the control circuit when the mechanical switch is open. The energy reservoir is formed for example by a capacitor or a chargeable battery.

It is also however possible to arrange the control circuit such that it is fed by the electromotor when the mechanical switch is open. The electromotor thus acts as an energy source. It is therefore important to ensure that the control circuit is suitable for processing the highly variable voltage generated by the motor as supply voltage.

A MOSFET is preferably used as the semiconductor element. This is a semiconductor element that has a polarity. When using such a semiconductor element with a polarity, it is advantageous for the two elements to have opposite polarities. To drive the elements, a gate voltage is required that is referred to with respect to the voltage at source. On the basis of a MOSFET that is switched between the electromotor and the negative terminal of the battery, the source—during operation—is connected to the negative terminal of the battery and the controlling process takes place with a positive voltage. During the braking process, the connection between the motor and the negative terminal of the battery is broken, but the motor remains connected to the positive terminal of the battery. To control the element acting as a bypass switch, a voltage lower than the positive battery voltage is available—without requiring any further measures. To be able to use this voltage as a control supply voltage, a MOSFET is required having a polarity that is opposite to that of the MOSFET acting as a controlling element.

The invention also relates to an electric hand tool in which the control circuit according to the invention is applied, namely an electric hand tool that is arranged to be fed by a battery and provided with a control circuit according to one of the preceding claims.

Further features of the present invention will emerge from the accompanying figures, in which the following are shown:

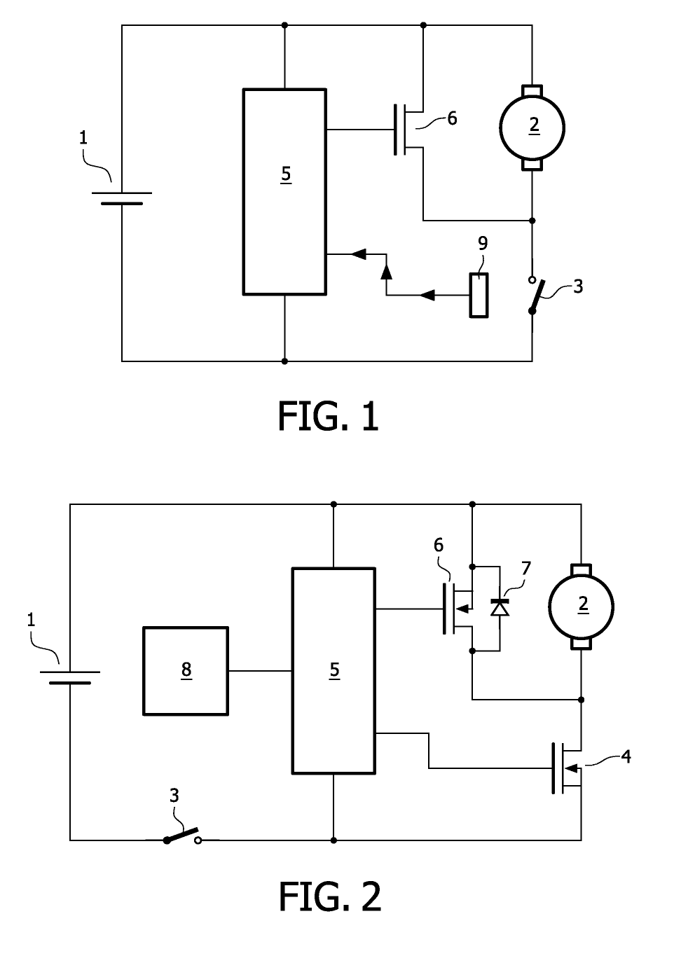

FIG. 1: a diagram of a first circuit according to the invention;

FIG. 2: a diagram of a second circuit according to the invention; and

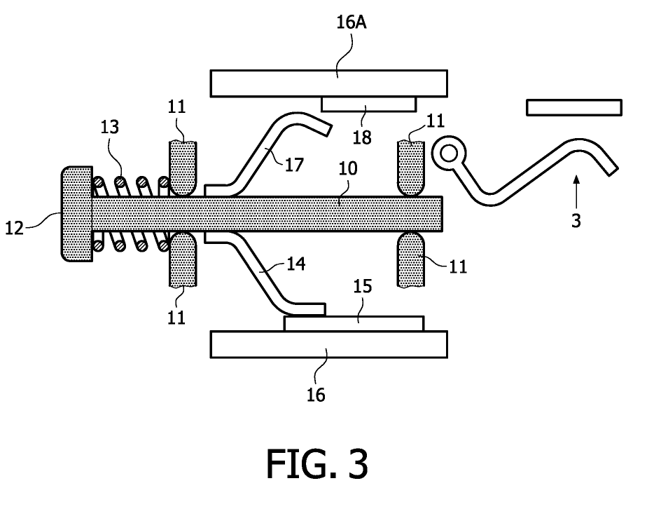

FIG. 3: a schematic three-dimensional view of a mechanical embodiment of a controlling circuit according to the invention.

As shown in FIG. 1, the circuit comprises a chargeable battery or accumulator 1, an electromotor 2 and a mechanical switch 3 connected between the negative terminal of the battery 1 and the motor 2. Such a circuit is incorporated for example in an electric hand tool, such as a circular saw, whereby the motor is arranged for driving the saw plate of the circular saw. This concerns a type of machine in which speed control is of less importance. Thus far, the circuit corresponds to generally known circuits for switching the power of the motor 2.

The invention relates in particular to a semiconductor bypass element that is formed by a FET 6 in the example in question. To control the FET 6, a control circuit 5 is incorporated, said control circuit being connected to a detector 9 that is arranged for detecting the position of the mechanical switch 3.

This circuit functions as follows: The motor 2 of the electrical device, of which the circuit shown forms part, is switched on by switching on the switch 3. This closes the electric circuit of the accumulator or battery 1, the switch 3 and the electromotor 2. At this point it is important for the semiconductor 6 acting as a bypass switch to turn out to be in its non-conducting state, in order to prevent bypassing. To this end, the detector 9 signals to the control circuit 5 that the switch 3 is closed, thus preventing the semiconductor 6 from opening. The detector can be designed in various ways, for example as an auxiliary contact on the switch 3, as a Hall element or as an optical element.

When the sawing is finished, the switch 3 is opened, so that the electromotor 2 is no longer fed. Without requiring any further measures, this motor will slow down. The control circuit 5 receives the signal from the detector 9 that the switch 3 is open, after which the semiconductor 6 is opened. This causes the motor 2 that is now no longer fed to bypass, so that a bypass current will start flowing, in turn braking the motor. The control circuit 5 is preferably arranged such that the value of the bypass current gradually increases to protect the device from shocks and excessive wear and tear, in particular the electromotor and carbon brushes mounted therein.

In the present embodiment, a facility is preferably incorporated for switching off the control circuit once the electromotor has come to a rest, to prevent the accumulator 1 from depleting. This can also per se be achieved by positioning the switch 3 between the accumulator 1 and the terminal of the control circuit. However, facilities would then be required to feed the control circuit during the braking process, because the switch has broken the control circuit power supply.

A second embodiment of a circuit according to the invention is shown in FIG. 2, which differs from the circuit in FIG. 1 in that an electronic switching element 4 is added to the switch 3. This electronic switching element 3 offers the option of continuously controlling the power supplied to the electromotor. This is particularly important with specific types of appliances, such as drilling or screwing machines. This feature is otherwise already known per se.

To control this electronic element, such as an MOSFET, a control circuit is required. For this purpose, it is possible to use the already present control circuit 5 already applied for controlling the bypass switch. This arrangement is also advantageous in that this control circuit 5 can control both semiconductors, thus preventing the simultaneous conduction of both semiconductors. The detector is hereby considered to be included in the control circuit.

The switch 3 is moved to the position already referred to as an alternative in the description of the first figure. To feed the control circuit, a capacitor 8 is therefore also present. This capacitor 8 is being charged when the switch 3 is closed. Instead of a capacitor, it is possible to use another storage unit for energy, such as a small accumulator. Otherwise it is also possible for the control circuit 5 to be fed by the motor during the braking process. To this end, the control circuit must obviously be arranged to be supplied by a highly variable, decreasing voltage.

Reference is finally made to the type of semiconductor that can be used as an electronic switching element. The use of MOSFETs is advantageous in that they are intrinsically provided with a freewheeling diode, so that this does not have to be added as an additional component. In the prior art it has been interesting to apply MOSFETs having an opposite polarity. Indeed this has advantages in terms of the voltage level of the controlling process as emerged in the introductory description. However, it is very possible for later developments to lead to situations in which the disadvantage of applying voltage levels that can only be achieved using auxiliary means to be countered by the advantages of using MOSFETs with equal polarity.

FIG. 3 shows a part of the mechanical elements of the circuit according to the invention. These elements comprise a sliding element 10 that is incorporated between conductors 11 in a sliding fashion. At one end, the sliding element 11 comprises a button 12, which is used to drive the sliding element against the force generated by a spring 13. The mechanical switch 3 is positioned at the other end of the sliding element 10. A slider 14 is attached to the sliding element, with the slider moving in a sliding fashion over a track 15 acting as a potentiometer, said track being affixed on a sheet 16 acting as a carrier. The parts hitherto described of the mechanical elements correspond to the prior art.

For the invention to function, in other words to apply a bypass switch 7 designed as a semiconductor switch, it is attractive to use a detector that checks whether the mechanical switch is open. To this end, a second slider 17 attached to the sliding element 10 is used, said slider moving in a sliding fashion over a second sheet 16A, on which a conductor 18 is affixed, such that contact is only made between the slide 17 and the conductor 18 when the sliding element 10 is moved so far back under the action of the spring 13 that the mechanical switch 3 is opened. A detector is thus obtained to detect the status of the mechanical switch 3. It should be noted that this embodiment forms an alternative to the embodiment shown in FIG. 2, in which an electronic approach is adopted to prevent the semiconductor switches 4, 6 from both conducting simultaneously.

It should be noted that the embodiment shown is only intended for the purpose of clarifying the functionality and that there are numerous options for achieving this functionality in another way, for example by adjusting the structure of the switch 3.

The functioning of the present circuit will emerge from the description below. To allow the machine, of which the arrangement according to the invention forms part, to function, the button 12 is pressed, in turn moving the sliding element 10 in a longitudinal direction and switching on the mechanical switch. Furthermore, the slider 14 will then move over the carbon brush 15, thus adjusting the output voltage of the slider 14 connected as a potentiometer and track 15. This potentiometer incorporated anyway in the control circuit 5 acts as an input signal for the controlling circuit 5. The degree of conduction of the FET 4 is thus determined and so too the power supplied to the electromotor 2.

If the user wants to stop the electromotor 2, he lets go of the button 12, causing the spring 13 to move the sliding element 10 back to its starting position. This causes the switch 3 to open, in turn stopping the supply of power to the electromotor 2. The slider 17 also makes contact with conductor track 18, in turn activating the braking function of the control circuit 5. The opening of the switch 3 causes the control circuit 5 to be deprived of power supplied by battery 1. To this end, power from the capacitor 8 is used.

This causes the semiconductor switch 6 acting as a bypass switch to open, in turn causing the electromotor 2 to start functioning as a generator and the kinetic energy from the electromotor 2 and tool connected thereto to be converted into electrical energy. This electrical energy is dissipated in the ohmic resistance of the electromotor. In this way it is possible to control the degree of braking of the electromotor 2 by controlling the degree of conduction of the semiconductor switch 6.

Otherwise, the energy being released can be dissipated in an external resistor that for example is connected in series to the semiconductor switch 6 acting as a bypass switch. It is also possible to use the energy being released to feed the control circuit 5.

1. Control circuit for an electric hand tool fed by a DC power supply, whereby the control circuit is arranged for controlling the power supplied from the DC power supply to an electromotor and whereby the control circuit comprises:
a switching element connected in series to the motor;
a bypass switch connected in parallel to the electromotor for braking the electromotor by means of bypassing, whereby the bypass switch is formed by a semiconductor, characterized in that the control circuit comprises a control circuit for controlling the bypass switch and a detector connected to the control circuit for detecting the status of the switching element.

2. Control circuit according to claim 1, characterised in that the control circuit is arranged for gradually increasing the conduction of the bypass switch once the switching element is open, in that the bypass switch is of the switching type, and in that the conduction of the bypass switch is achieved by varying the duty cycle of the bypass switch.

3. Control circuit according to claim 1, characterised in that the switching element comprises an electronic switching element of the switching type and the control circuit comprises a control circuit that is arranged for controlling the electronic switching element.

4. Control circuit according to claim 3, characterised in that the control circuit comprises a microprocessor.

5. Control circuit according to claim 1, characterised in that the switching element comprises a series connection to a mechanical switch and a semiconductor switch and in that the detector is arranged for detecting the position of the mechanical switch.

6. Control circuit according to claim 5, characterised in that the control circuit for the power supply is connected to the connection point between the mechanical switch and the electronic switching element and in that the control circuit is connected to a storage reservoir for electrical energy.

7. Control circuit according to claim 5, characterised in that the control circuit for the power supply is connected to the connection point between the mechanical switch and the electronic switching element and in that the control circuit is arranged so that it is fed by the electromotor when the switching element is opine.

8. Control circuit according to claim 1, characterized in that the semiconductor elements have a polarity and in that the polarity of the switching element is opposite to that of the semiconductor acting as a bypass switch.

9. Electric hand tool, comprising a control circuit according to claim 1.

10. Control circuit according to claim 2, characterised in that the switching element comprises an electronic switching element of the switching type and the control circuit comprises a control circuit that is arranged for controlling the electronic switching element.

11. Control circuit according to claim 10, characterised in that the control circuit comprises a microprocessor.

12. Control circuit according to claim 2, characterised in that the switching element comprises a series connection to a mechanical switch and a semiconductor switch and in that the detector is arranged for detecting the position of the mechanical switch.

13. Control circuit according to claim 3, characterised in that the switching element comprises a series connection to a mechanical switch and a semiconductor switch and in that the detector is arranged for detecting the position of the mechanical switch.

14. Control circuit according to claim 4, characterised in that the switching element comprises a series connection to a mechanical switch and a semiconductor switch and in that the detector is arranged for detecting the position of the mechanical switch.

15. Control circuit according to claim 10, characterised in that the switching element comprises a series connection to a mechanical switch and a semiconductor switch and in that the detector is arranged for detecting the position of the mechanical switch.

16. Control circuit according to claim 11, characterised in that the switching element comprises a series connection to a mechanical switch and a semiconductor switch and in that the detector is arranged for detecting the position of the mechanical switch.

17. Control circuit according to claim 2, characterized in that the semiconductor elements have a polarity and in that the polarity of the switching element is opposite to that of the semiconductor acting as a bypass switch.

18. Control circuit according to claim 3, characterized in that the semiconductor elements have a polarity and in that the polarity of the switching element is opposite to that of the semiconductor acting as a bypass switch.

19. Control circuit according to claim 4, characterized in that the semiconductor elements have a polarity and in that the polarity of the switching element is opposite to that of the semiconductor acting as a bypass switch.

20. Control circuit according to claim 10, characterized in that the semiconductor elements have a polarity and in that the polarity of the switching element is opposite to that of the semiconductor acting as a bypass switch.
